(19) United States
(12) Patent Application Publication
(10) Pub. No.: US 2003/0042652 A1
(43) Pub. Date: Mar. 6, 2003

(54) Method for spin stretching polymers

(76) Inventors: Olaf Meister, Monchberg (DE); Wolfgang Peschke, Obernburg (DE); Eberhard Ruf, Rodenbach (DE); Diederich Schilo, Klingenberg (DE); Thomas Zang, Goldbach (DE)

Correspondence Address: Oliff & Berridge, PO Box 19928, Alexandria, VA, 22320, US

(21) Appl. No.: 10/168,109

(22) PCT Filed: Dec. 9, 2000
(86) PCT No.: PCT/EP00/12473

(30) Foreign Application Priority Data
Dec. 23, 1999 (DE) 19962276.0

(51) Int. Cl. B29C 47/88

(52) U.S. Cl. 264/211.15

(57) ABSTRACT

The invention relates to a process for simultaneous spin-drawing of one or more heavy-duty yarns, comprising the following steps:

a) a polymer melt is fed to a spinning device; b) the melt is extruded through a spinneret with multiple extrusion orifices to produce filaments; c) the filaments are led through a blowing zone; d) the filaments are guided through a quenching cell; e) the filaments are tensioned between a feed roll and a first draw roll; f) the filaments are then drawn between the first draw roll and a second draw roll; g) the filaments are relaxed between the second draw roll and a relax roll; h) the filaments are taken up by a winder, a lubricant also being applied in a lubricating unit to the filaments during the process;

and characterized in that polyamide yarns are produced, that drawing is carried out for in a substantially dry atmosphere, and that the arithmetic mean Ra of the surface roughness of the roll used as the first draw roll is at least 0.2 μm.

The invention relates to a process for simultaneous spin-drawing of one or more heavy-duty yarns, comprising the following steps: a) a polymer melt is fed to a spinning device; b) the melt is extruded through a spinneret with multiple extrusion orifices to produce filaments; c) the filaments are led through a blowing zone; d) the filaments are guided through a quenching cell; e) the filaments are tensioned between a feed roll and a first draw roll; f) the filaments are then drawn between the first draw roll and a second draw roll; g) the filaments are relaxed between the second draw roll and a relax roll; h) the filaments are taken up by a winder, a lubricant also being applied in a lubricating unit to the filaments during the process.

A process of this type has been described in U.S. Pat. No. 4,349,501. This patent discloses a process for simultaneous spin-drawing of polyester yarns, in which (a) a polyester melt is fed to a spinning unit; (b) the melt is extruded through an extrusion device to form filaments; (c) the filaments formed are fed through an air column at a temperature between 200 and 450° C., and are then (d) led through a cooling zone, and (e) provided with a lubricant; (f) the filaments after lubrication are passed over a feed roll at a temperature lower than 50° C.; (g) the filaments are then passed through a steam-impinging draw-point localizing jet where the steam temperature is between 482 and 580° C.; (h) the filaments are passed over a pair of draw rolls maintained at a temperature between 170 and 237° C.; (i) the filaments are passed over a relax roll system maintained at a temperature between 60 and 230° C., and are finally wound up at a tension between 0.06 and 1 gram per denier.

According to U.S. Pat. No. 4,349,501, this process yields polyester yarns with low shrinkage and good dimensional stability in a single-stage process. These polyester yarns are particularly well suited for manufacturing tires and other industrial yarn products such as safety belts and conveyor belts. The patent teaches that the results are obtained according to the invention by raising the steam temperature during the drawing process (see in particular Examples 2 to 8 of U.S. Pat. No. 4,349,501); the intended purpose is to enhance crystalline development of the polyester yarns and thus to yield the aforementioned advantages, without the need for a winding step between spinning and drawing, or for subsequent cost-intensive steps such as tempering of the yarns.

Although the process described in U.S. Pat. No. 4,349,501 leads to useful results in the case of polyester yarns, the use of other fiber-forming polymers leads to problems. If, for example, polyamides are subjected to the process described in the U.S. patent, the resulting strength and elongation properties are not as consistently good as those obtained from the corresponding known two-stage processes in which spinning and drawing are performed in separate steps. This applies particularly when attempts are made in this manner to obtain polyamide yarns with relatively fine titer, e.g., under 500 dtex, and high strength. The process described in the U.S. patent is therefore not very suitable for polymers other than polyesters, and U.S. Pat. No. 4,349,501 consequently also mentions only polyesters.

The object of the present invention, therefore, is to adapt for use with polyamides the single-stage spin-drawing process that is prior art for polyesters.

The object is achieved with a process for simultaneous spin-drawing of one or more heavy-duty yarns, as described in the preamble of claim 1, characterized in that polyamide yarns are produced, that drawing is carried out in a substantially dry atmosphere, and that the arithmetic mean Ra of the surface roughness of the first draw roll used is at least 0.2 μm.

The process of the present invention allows the prior art spin-drawing process that is suitable only for polyesters to be applied also to polyamide, with the particular advantage that even high-strength polyamide yarns of relatively fine titer can be obtained.

In particular, no indication was available from the prior art that adjustment, in accordance with the invention, of the surface roughness of the draw roll would allow the process to be applied to spin-drawing of polyamide yarns.

According to the process of the invention, a substantially dry atmosphere is one in which only the normal atmospheric equilibrium humidity for the respective process temperature prevails during drawing. In the process of the invention, drawing is generally carried out in an atmosphere of relative humidity not greater than 65%, and preferably between 55 and 65%, measured at a temperature of 20+/−2° C. In particular, the process of the present invention involves no steam treatment of the yarns during drawing.

A spin-drawing process of this type allows practically all spinnable polyamides to be processed into the corresponding polyamide yarns. Polyamide 6, polyamide 6,6, polyamide 4,6, their copolymers, and blends of these polymers are particularly suitable polyamides for the process of the invention.

The roughness of the roll surfaces, and particularly the roughness of the first draw roll, plays a decisive role in the process of the present invention.

The measurement of surface roughness is known per se to those skilled in the art. The arithmetic mean Ra of the surface roughness (also known as the centerline average roughness, Ra) used in the present invention is the arithmetic mean of the absolute values of the roughness-profile data; it is defined as in DIN 4768 and ISO 4287/1 and can be measured by conventional methods.

A suitable device for measurement of the centerline average roughness is, for example, the S5P Perthometer made by Mahr in Göttingen, Germany (trace length=1.5 mm, cut-off wavelength=0.25 mm). Rolls of defined roughness are commercially available.

In the process of the present invention, it is preferable to use as the first draw roll a roll for which the arithmetic mean Ra of the surface roughness is at most 6 μm.

For most applications of the process of the invention, it is advantageous if the arithmetic mean Ra of the surface roughness of the roll used as the first draw roll satisfies

the condition: 0.5 μm≦Ra≦3.0 μm and preferably 0.8 μm≦Ra≦2 μm.

The surface roughness, as described in the present invention, of the first draw roll allows wide-ranging adjustment and variation of the tensioning and drawing that are to be carried out using this roll.

In the process of the invention, it is preferable if the draw ratio for the initial tension between the feed roll and the first draw roll is set to a value between 1:1.01 and 1:1.15, and preferably between 1:1.03 and 1:1.1.

For drawing between the first and second draw rolls, it is advantageous to use a draw ratio between 1:3.5 and 1:6, and preferably between 1:4 and 1:5.

The yarns drawn in this way are then relaxed. In this relaxation step that follows drawing, it has proven especially practical to use a draw ratio, for the relaxation between the second draw roll and the relax roll, in the range 1:0.85 to 1:1, preferably approx. 1:0.9 to 1:0.99.

The individual rolls used in the spin-drawing process of the invention are brought to a temperature appropriate to their function. Although in principle a person skilled in the art can easily determine by simple experimentation the temperatures most suitable for the given requirements, e.g., for the particular polymer used, or the titer, the preferred modes for carrying out the required process will be described below.

In regard to the feed roll, for example, it has proven advantageous to use it unheated.

The temperature of the first draw roll is preferably between 30 and 120° C. The temperature of the first draw roll that is most favorable for the drawing process naturally depends on the titer; the following values may serve as guidelines and examples: approx. 55° C. for 110 dtex, approx. 65° C. for 235 dtex, approx. 75° C. for 350 dtex, and approx. 75° C. for 470 dtex .

The second draw roll should preferably be brought to a temperature above 160° C., and more preferably to temperatures above 200° C. The upper limit of temperature for the process is regarded as the melting point of the polymers used.

Finally, the preferred temperature for the relax roll is between ambient temperature and 150° C. This temperature range depends, among other things, on the temperature of the second draw roll in the process. Heating the relax roll has a positive effect on process stability.

The spin-drawing apparatus described above is in general excellently suited for producing polyamide yarns with the required strength and elongation properties. In some cases, however, and particularly where very high strengths are required, it can be useful to incorporate an additional heating element in the path of the yarn. It has been found particularly advantageous in such cases to place the additional heating element between the first and second draw rolls. The heating element used for this purpose may be a hotplate, heater bar, or heating pin, which are known per se to those skilled in the art. It has proven advantageous in the process of the invention for the temperatures of the heating element to be in the range 100-240° C. and preferably approx. 150-200° C.

The yarn is wound up at the end of the spin-drawing process. The winding speed is preferably set to a value between 1000 and 2500 m/min. Any commercially available winder capable of handling these speeds can generally be used. Automatic winders, particularly those with turrets or revolving heads, have been found to be suitable for the claimed process. Winding devices of this kind are known to those skilled in the art.

The winding of the yarns may of course begin directly after they leave the relax roll. It has, however, proven to be advantageous if winding of the filaments is started no earlier than 0.024 s, and preferably between 0.024 and 0.3 s, after the filaments have left the relax roll. If winding is begun with the delay indicated, the process is notably more stable and operational safety is thereby improved.

The surface roughness of the first draw roll is of critical importance in the process of the present invention. The roughness of the other rolls in the process is generally less critical. It has been shown, however, that a preferred range of surface roughness also exists for the other rolls. It is advantageous, for example, if, for each of the rolls used as a feed roll, second draw roll, and relax roll, the arithmetic mean Ra of the surface roughness satisfies the condition 0.5 μm≦Ra≦3 μm.

If the rolls used in the process of the invention are single rolls, they are usually provided with idler rolls or scrolls, depending on how they are used. The yarns are generally wound multiple times on the rolls (e.g., a 6-fold winding). For certain applications it is advantageous to use a draw roll duo in place of the second draw roll and corresponding idler roll. The draw roll duo serves the same purpose as the second draw roll and also has the same properties, e.g., preferred roll temperature and surface properties. Of course, the yarns are also wound onto the draw roll duo, usually multiple times. Drawing by the process of the invention therefore occurs in this case between the first draw roll and the draw roll duo.

A lubricant is applied to the yarns in the process of the invention. The use of non-aqueous lubricants such as petroleum-based lubricants or neat oils is preferred. The lubricant is applied during the process by means of a conventional lubricating unit, such as a lubricating roll or nozzle, during the passage of the yarn. It is advantageous to place the lubricating unit between the quenching cell and the feed roll. In this case the lubricant is applied only after the yarn has left the quenching cell. However, it can also be advantageous to insert the lubricating unit between the blowing zone and the quenching cell. In this case the lubricant is applied immediately after blowing.

A person skilled in the art may choose between the two aforementioned arrangements in accordance with the properties required in the yarns to be produced.

In general the yarns are also entangled during the process. Entangling, which consists of intermingling the filaments to effect yarn cohesion, may optionally be carried out at different points in the process. Multiple entangling operations may also be carried out.

It may, for example, be advantageous to incorporate an entangling unit between the quenching cell and the feed roll or between the lubricating unit and the feed roll, depending on the yarn parameters required.

Furthermore, it is possible in principle, and may be desirable, to use an entangling unit solely or additionally between the second draw roll and the relax roll.

Finally, it has also proven advantageous to use an entangling unit solely or additionally between the relax roll and the winder.

By simple experimentation, a person skilled in the art can easily select the entangling unit location(s) that is (are) best suited for conducting the process.

The yarn data for the polyamide filaments obtained via the claimed process may in principle be adjusted within wide limits. For many applications, however, it has proven advantageous to carry out the process steps in such a way that the polyamide filaments obtained have a fibril titer of 1.0 to 7 dtex .

It is also advantageous if the polyamide filaments obtained have a strength of between 40 and 100 cN/tex.

Finally, the preferred range of elongation for the polyamide filaments obtained is 10-40%.

The polyamide yarns obtained are highly suitable for production of all kinds of flat structures, particularly woven airbag fabrics.

The invention therefore applies primarily to flat structures, particularly woven airbag fabrics, containing polyamide filaments that can be produced by the process of the invention.

The process of the invention will now be described in detail with the help of two figures, where

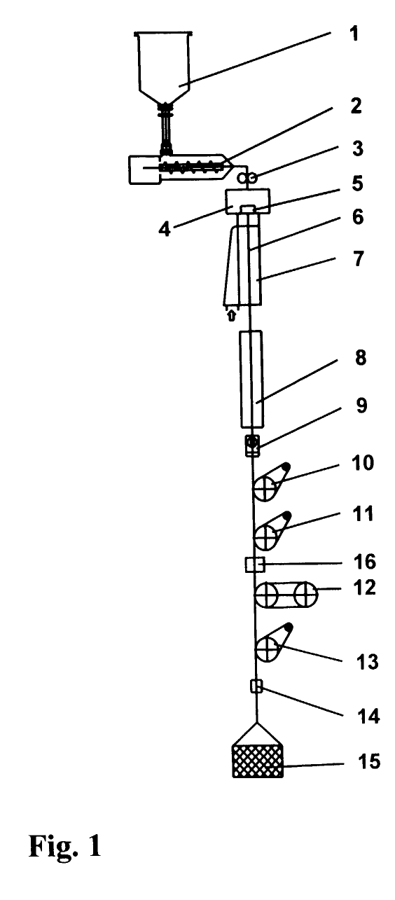

FIG. 1 shows a suitable apparatus for the process of the invention, and

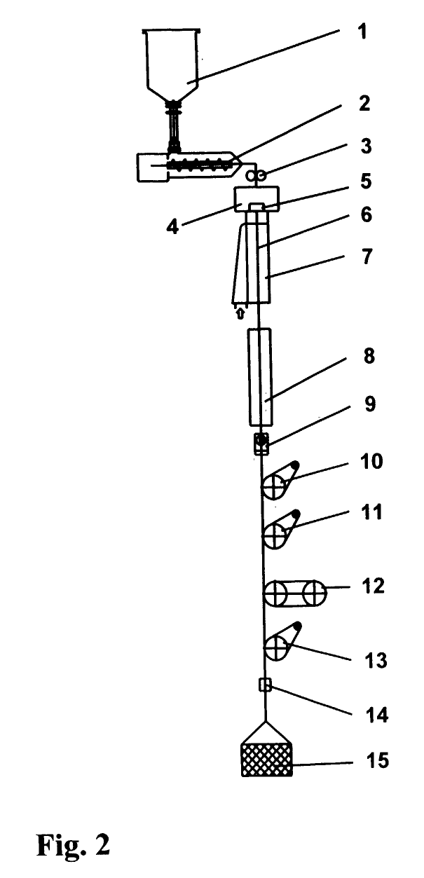

FIG. 2 shows another suitable apparatus for the process of the invention.

In the configuration of FIG. 1, the polymer is first dried in a dryer 1 until the residual moisture content has reached the required value. The dried polymer chips are melted in an extruder 2 and the melt is fed by means of a spin pump 3 to a spin block 4 and extruded through a spinneret 5 to form filaments 6. The filaments are cooled by a stream of gas, such as air, in a blowing zone 7 (the direction of the stream is indicated by an arrow in the diagram), and then guided through a quenching cell 8. A lubricant is then applied from the lubricating unit 9. The filaments are then tensioned between the feed roll 10 and the first draw roll 11, and brought to the required draw ratio between the first draw roll 11 and a draw roll duo 12 as the second draw roll. During this drawing, the filaments are heated by the hotplate 16 that serves as a heating element. The filaments are relaxed between the draw roll duo 12 and the relax roll 13 and then entangled by an entangling unit 14. Finally, the filaments are wound up on the winder 15.

FIG. 2 shows the same arrangement as FIG. 1, except that there is no additional heating element between the first draw roll 11 and the draw roll duo 12.

The process described will be illustrated in detail with the help of the following Examples 1-8 and two comparison examples, preceded by a table showing the essential features of the process conditions and the properties of the yarns obtained. All the trials were carried out using the configuration of FIG. 2.

The following remarks apply to the table.

The moisture content of the granulate was determined by heating a sample in a vacuum to 200° C. and reading off the resulting vapor pressure. The moisture content of the granulate can then be determined from a calibration curve.

The relative solution viscosity was measured in a standard Ubbelohde viscometer, a solution of 250 mg polyamide in 30 g formic acid having been prepared previously. The measurement was performed at 25° C. The flow times of the solution and the solvent in the same viscometer were measured; the ratio of the two is the relative viscosity.

The applied lubricant is determined by extracting the yarns with petroleum ether (boiling range 50-70° C.) in a Soxhlet apparatus and weighing the extract.

The Uster CV 100 values were determined by an Uster UT4-CX/A tester as values for titer uniformity. The measurement was performed at 20° C. and 65% relative humidity. The testing speed was 100 m/min for 2.5 min.

Filament sections of 1.50 m were taken for measurement of hot-air shrinkage (HL 190). Two knots, 1 m apart, were made in these sections. The sections were then rolled together and relaxed for approx. 30 minutes, after which the distance between the knots was measured. This was followed by hot-air treatment in an oven at 190° C. for 15 minutes. After 30 minutes of conditioning in a standard atmosphere at 20° C. and 65% relative humidity, the distance between the two knots was remeasured. The change in yarn length is based on the original value.

The opening length is measured using the Rothschild R-2070 A entanglement tester. The test was performed at 20° C. and 65% relative humidity. In the titer range tested, the initial tension was 10 cN and the trip level of the needle was between 30 and 80 cN.

Measurement of strength and elongation was carried out on a Textechno Statimat M.

As is clear from the table, the process of the invention yields yarns distinguished by their high strength and low elongation, and therefore offers a single-stage spin-drawing process that is suitable for polyamides.

TABLE

| | | | | | | | | | | Com- | Com- |
|---|---|---|---|---|---|---|---|---|---|---|---|
| | Units | 1 | 2 | 3 | 4 | 5 | 6 | 7 | 8 | parison | parison |
| Polymer | | PA 6,6 | PA 6,6 | PA 6,6 | PA 6,6 | PA 6,6 | PA 6,6 | PA 6,6 | PA 6,6 | PA 6,6 | PA 6,6 |
| Titer | dtex | 235 f 36 | 235 f 72 | 235 f 72 | 470 f 72 | 470 f 72 | 470 f 72 | 470 f 72 | 235 f 72 | 235 f 72 | 235 f 72 |
| Moisture content | % | 0.043 | 0.053 | 0.035 | 0.035 | — | 0.033 | 0.028 | 0.048 | 0.048 | 0.048 |
| after drying | | | | | | | | | | | |
| (granulate) | | | | | | | | | | | |
| Relative | | 2.573 | 2.49 | 2.500 | 2.541 | — | 2.544 | 2.544 | 2.735 | 2.735 | 2.735 |
| viscosity (granu- | | | | | | | | | | | |
| late) | | | | | | | | | | | |
| Relative humid- | %/° C. | 60/20 | 60/20 | 60/20 | 60/20 | 60/20 | 60/20 | 60/20 | 60/20 | 60/20 | 60/20 |
| ity/temperature | | | | | | | | | | | |
| (during | | | | | | | | | | | |
| drawing) | | | | | | | | | | | |
| Spinning | | | | | | | | | | | |
| Extruder | ° C. | 280 | 280 | 280 | 280 | 280 | 280 | 280 | 280 | 280 | 280 |
| temperature, | | | | | | | | | | | |
| zone 1 | | | | | | | | | | | |
| Extruder | ° C. | 300 | 300 | 300 | 300 | 300 | 300 | 300 | 300 | 300 | 300 |
| temperature, | | | | | | | | | | | |
| zone 2 | | | | | | | | | | | |
| Extruder | ° C. | 301 | 301 | 301 | 301 | 301 | 301 | 301 | 301 | 301 | 301 |
| temperature, | | | | | | | | | | | |
| zone 3 | | | | | | | | | | | |
| Temperature | ° C. | 307 | 307 | 307 | 307 | 307 | 307 | 307 | 307 | 307 | 307 |
| of heating | | | | | | | | | | | |
| chamber | | | | | | | | | | | |
| Spinneret | (n/μm) | 36/250 | 72/200 | 72/200 | 72/200 | 72/200 | 72/200 | 72/200 | 72/200 | 72/200 | 72/200 |
| (no. of holes/μm) | | | | | | | | | | | |
| Diameter of | mm | 80 | 80 | 80 | 80 | 80 | 80 | 80 | 80 | 80 | 80 |
| spinneret | | | | | | | | | | | |
| Throughput | g/min | 45.0 | 52.7 | 44.1 | 55.9 | 82.8 | 81.5 | 81.5 | 44.1 | 44.1 | 44.1 |
| Lubricant | | non- | non- | non- | non- | non- | non- | non- | non- | non- | non- |
| | | aqueous | aqueous | aqueous | aqueous | aqueous | aqueous | aqueous | aqueous | aqueous | aqueous |
| Application | % | 0.91 | 0.48 | 0.48 | — | 0.46 | 0.40 | 0.44 | 0.50 | 0.47 | 0.50 |
| Feed roll | | | | | | | | | | | |
| Speed | m/min | 408 | 492 | 416.9 | 236.7 | 361 | 361 | 361 | 416.9 | 416.9 | 435.8 |
| Temperature | | not | not | not | not | not | not | not | not | not | not |
| | | heated | heated | heated | heated | heated | heated | heated | heated | heated | heated |
| Surface material | | polished | dull hard | polished | polished | dull hard | dull hard | dull hard | polished | polished | polished |
| | | hard | chrome | hard | hard | chrome | chrome | chrome | hard | hard | hard |
| | | chrome | | chrome | chrome | | | | chrome | chrome | chrome |
| Surface | μm | 0.43 | 1.66 | 0.43 | 0.43 | 1.66 | 1.66 | 1.66 | 0.43 | 0.43 | 0.43 |
| roughness Ra | | | | | | | | | | | |
| First draw roll | | | | | | | | | | | |
| Speed | m/min | 432.5 | 521.5 | 441.9 | 250.9 | 382.7 | 382.7 | 382.7 | 441.9 | 441.9 | 462 |
| Temperature | ° C. | 65 | 65 | 65 | 75 | 75 | 75 | 75 | 65 | 65 | 65 |
| Surface material | | plasma | plasma | plasma | plasma | plasma | plasma | dull hard | plasma | polished | polished |
| | | | | | | | | chrome | | hard | hard |
| | | | | | | | | | | chrome | chrome |
| Surface | μm | 1.18 | 1.18 | 1.18 | 1.18 | 1.18 | 0.703 | 3.96 | 0.951 | 0.136 | 0.136 |
| roughness Ra | | | | | | | | | | | |
| Draw roll duo | | | | | | | | | | | |
| Speed | m/min | 2033 | 2346 | 2032.7 | 1279.4 | 1836.7 | 1836.7 | 1836.7 | 2032.7 | 2032.7 | 2032.7 |
| Temperature | ° C. | 235 | 235 | 235 | 240 | 235 | 235 | 235 | 235 | 235 | 235 |
| Surface material | | dull hard | dull hard | dull hard | dull hard | dull hard | dull hard | dull hard | dull hard | dull hard | dull hard |
| | | chrome | chrome | chrome | chrome | chrome | chrome | chrome | chrome | chrome | chrome |
| Surface | μm | 1.12/1.5 | 1.12/1.5 | 1.12/1.5 | 1.12/1.5 | 1.12/1.5 | 1.12/1.5 | 1.12/1.5 | 1.12/1.5 | 1.12/1.5 | 1.12/1.5 |
| roughness Ra | | | | | | | | | | | |
| Relax roll | | | | | | | | | | | |
| Speed | m/min | 1992 | 2300 | 1992 | 1250 | 1800 | 1800 | 1800 | 1992 | 1992 | 1992 |
| Temperature | ° C. | 95 | 79.8 | 75 | 100 | 109 | 110 | 108 | 75 | 75 | 75 |
| Surface material | | dull hard | dull hard | dull hard | dull hard | dull hard | dull hard | dull hard | dull hard | dull hard | dull hard |
| | | chrome | chrome | chrome | chrome | chrome | chrome | chrome | chrome | chrome | chrome |
| Surface | μm | 0.87 | 0.87 | 0.87 | 0.87 | 0.87 | 0.87 | 0.87 | 0.87 | 0.87 | 0.87 |
| roughness Ra | | | | | | | | | | | |
| Winding | | | | | | | | | | | |
| Speed | m/min | 1956 | 2265.5 | 1958.1 | 1218.8 | 1762.2 | 1760.4 | 1756.8 | 1956.1 | 1956.1 | 1960.1 |
| Drawing stages | | | | | | | | | | | |
| Initial tension | 1: | 1.06 | 1.06 | 1.06 | 1.06 | 1.06 | 1.06 | 1.06 | 1.06 | 1.06 | 1.06 |
| between feed | | | | | | | | | | | |
| roll and first | | | | | | | | | | | |
| draw roll | | | | | | | | | | | |
| Drawing between | 1: | 4.7 | 4.5 | 4.6 | 5.1 | 4.8 | 4.8 | 4.8 | 4.6 | 4.6 | 4.4 |
| first draw | | | | | | | | | | | |
| roll and draw | | | | | | | | | | | |
| roll duo | | | | | | | | | | | |
| Drawing between | 1: | 0.98 | 0.98 | 0.98 | 0.98 | 0.98 | 0.98 | 0.98 | 0.98 | 0.98 | 0.98 |
| draw roll | | | | | | | | | | | |
| duo and | | | | | | | | | | | |
| relax roll | | | | | | | | | | | |
| Yarn data in | | | | | | | | | | Short | Short |
| drawn state | | | | | | | | | | spools | spools |
| Titer | dtex | 238.5 | 238.1 | 234.7 | 469.8 | 480.1 | 474.8 | 477.7 | 237.1 | only; | only; |
| Elongation | % | 20.7 | 20.7 | 21.92 | 21.7 | 21.7 | 21.7 | 19.3 | 20.8 | winding | winding |
| at rupture | | | | | | | | | | is nearly | is nearly |
| | | | | | | | | | | impossible | impossible |
| Strength | cN/tex | 81.1 | 83.4 | 80.8 | 81.8 | 79 | 79.5 | 76.2 | 78.9 | winding | winding |
| Opening length | cm | 2.19 | 1.88 | 4.51 | — | — | — | 5.3 | 3.7 | — | — |
| Uster (CV 100) | % | 0.86 | 0.9 | 1.02 | 1.15 | 1.31 | 1.29 | 1.93 | 1.5 | — | — |
| Hot-air shrinkage | % | 6.56 | — | 6.65 | — | — | — | — | 6.53 | — | — |

1. Process for simultaneous spin-drawing of one or more heavy-duty yarns, comprising the following steps:
a) a polymer melt is fed to a spinning device;
b) the melt is extruded through a spinneret with multiple extrusion orifices to produce filaments;
c) the filaments are led through a blowing zone;
d) the filaments are guided through a quenching cell;
e) the filaments are tensioned between a feed roll and a first draw roll;
f) the filaments are then drawn between the first draw roll and a second draw roll;
g) the filaments are relaxed between the second draw roll and a relax roll;
h) the filaments are taken up by a winder, a lubricant also being applied in a lubricating unit to the filaments during the process;
and characterized in that polyamide yarns are produced, that drawing is carried out in a substantially dry atmosphere, and that the arithmetic mean Ra of the surface roughness of the roll used as the first draw roll is at least 0.2 μm.

2. Process according to claim 1, characterized in that drawing is carried out in an atmosphere of relative humidity not greater than 65%, and preferably between 55 and 65%, measured at a temperature of 20+/−2° C.

3. Process according to one or more of claims 1 to 3, characterized in that polyamide 6, polyamide 6,6, polyamide 4,6, their copolymers, and blends of these polymers are used.

4. Process according to one or more of claims 1 to 3, characterized in that a roll for which the arithmetic mean Ra of the surface roughness is at most 6 μm is used as the first draw roll.

5. Process according to one or more of claims 1 to 3, characterized in that a roll for which the arithmetic mean Ra of the surface roughness satisfies the condition 0.5 μm≦Ra≦3 μm is used as the first draw roll.

6. Process according to one or more of claims 1 to 3, characterized in that a roll for which the arithmetic mean Ra of the surface roughness satisfies the condition 0.8 μm≦Ra≦2 μm is used as the first draw roll.

7. Process according to one or more of claims 1 to 6, characterized in that the draw ratio for the initial tension between the feed roll and the first draw roll is set to a value between 1:1.01 and 1:1.15.

8. Process according to one or more of claims 1 to 7, characterized in that a draw ratio between 1:3.5 and 1:6 is used for drawing between the first draw roll and the second draw roll.

9. Process according to one or more of claims 1 to 8, characterized in that the draw ratio for relaxation between the second draw roll and the relax roll is set to a value between 1:0.85 and 1:1.

10. Process according to one or more of claims 1 to 9, characterized in that an unheated feed roll is used.

11. Process according to one or more of claims 1 to 10, characterized in that the temperature of the first draw roll is set to a value between 35 and 120° C.

12. Process according to one or more of claims 1 to 11, characterized in that the temperature of the second draw roll is set to a value higher than 160° C.

13. Process according to one or more of claims 1 to 12, characterized in that the temperature of the relax roll is set to a value between ambient temperature and 150° C.

14. Process according to one or more of claims 1 to 13, characterized in that drawing is carried out with the help of a heating element positioned between the first draw roll and the second draw roll.

15. Process according to one or more of claims 1 to 14, characterized in that the winding speed is set to a value between 1000 and 2500 m/min.

16. Process according to one or more of claims 1 to 15, characterized in that winding of the filaments is started no earlier than 0.024 s, and preferably between 0.024 and 0.3 s, after the filaments have left the relax roll.

17. Process according to one or more of claims 1 to 16, characterized in that the arithmetic mean Ra of the surface roughness of each of the rolls used as a feed roll, second draw roll, and relax roll satisfies the condition 0.5 μm≦Ra≦3 μm.

18. Process according to one or more of claims 1 to 17, characterized in that a draw roll duo is used as the second draw roll.

19. Process according to one or more of claims 1 to 18, characterized in that the lubricating unit is positioned between the blowing zone and the quenching cell.

20. Process according to one or more of claims 1 to 18, characterized in that the lubricating unit is positioned between the quenching cell and the feed roll.

21. Process according to one or more of claims 1 to 20, characterized in that an entangling unit is positioned between the quenching cell and the feed roll, or between the lubricating unit and the feed roll.

22. Process according to one or more of claims 1 to 21, characterized in that an entangling unit is positioned between the second draw roll and the relax roll.

23. Process according to one or more of claims 1 to 22, characterized in that an entangling unit is positioned between the relax roll and the winder.

24. Process according to one or more of claims 1 to 23, characterized in that the process steps are carried out in such a way that the polyamide filaments obtained have a fibril titer of 1.0 to 7 dtex.

25. Process according to one or more of claims 1 to 24, characterized in that the process steps are carried out in such a way that the strength of the polyamide filaments obtained is between 40 and 100 cN/tex.

26. Process according to one or more of claims 1 to 25, characterized in that the process steps are carried out in such a way that the elongation of the polyamide filaments obtained is between 10 and 40%.

27. Flat structure, particularly woven airbag fabric, containing polyamide filaments that can be produced according to one or more of claims 1 to 26.
